(19) United States
(12) Patent Application Publication
(10) Pub. No.: US 2018/0178290 A1
(43) Pub. Date: Jun. 28, 2018

(54) METHOD FOR MANUFACTURING THREE-DIMENSIONAL SHAPED OBJECT

(71) Applicant: PANASONIC INTELLECTUAL PROPERTY MANAGEMENT CO., LTD., Osaka (JP)

(72) Inventors: Noboru URATA, Osaka (JP); Yoshiyuki UCHINONO, Osaka (JP); Satoshi ABE, Osaka (JP)

(73) Assignee: PANASONIC INTELLECTUAL PROPERTY MANAGEMENT CO., LTD., Osaka (JP)

(21) Appl. No.: 15/736,363

(22) PCT Filed: Feb. 9, 2016
(86) PCT No.: PCT/JP2016/054352

§ 371 Date: Dec. 14, 2017

(30) Foreign Application Priority Data
Jun. 25, 2015 (JP) 2015-127888

(51) Int. Cl. B22F 3/24; B22F 3/105; B33Y 10/00

(52) U.S. Cl. CPC B22F 3/24; B22F 2003/247; B33Y 10/00; B22F 3/1055

(57) ABSTRACT

Three dimensional shaped object manufacturing method, which is capable of making a life time of a machining tool longer when machining of the surface of a solidified layer is performed using the machining tool. The method includes an alternate repetition of forming a powder-layer and a solidified-layer. The repetition includes: forming a solidified layer by irradiating a predetermined portion of a powder layer with a light beam, thereby allowing a sintering of the powder in the predetermined portion or a melting and subsequent solidification of the powder; and forming another solidified layer by forming a new powder layer on the formed solidified layer, followed by irradiation of a predetermined portion of the newly formed powder layer with the light beam. A surface of the solidified layer is subjected to a machining process, and the machining process is performed on a basis of a condition of an ultrasonic vibration.

### TECHNICAL FIELD

The disclosure relates to a method for manufacturing a three-dimensional shaped object. More particularly, the disclosure relates to a method for manufacturing a three-dimensional shaped object, in which a formation of a solidified layer is performed by an irradiation of a powder layer with a light beam.

### BACKGROUND OF THE INVENTION

Heretofore, a method for manufacturing a three-dimensional shaped object by irradiating a powder material with a light beam has been known (such method can be generally referred to as “selective laser sintering method”). The method can produce the three-dimensional shaped object by an alternate repetition of a powder-layer forming and a solidified-layer forming on the basis of the following (i) and (ii):

(i) forming a solidified layer by irradiating a predetermined portion of a powder layer with a light beam, thereby allowing a sintering of the predetermined portion of the powder or a melting and subsequent solidification of the predetermined portion; and

(ii) forming another solidified layer by forming a new powder layer on the formed solidified layer, followed by similarly irradiating the powder layer with the light beam.

This kind of the manufacturing technology makes it possible to produce the three-dimensional shaped object with its complicated contour shape in a short period of time. The three-dimensional shaped object can be used as a metal mold in a case where inorganic powder material (e.g., metal powder material) is used as the powder material. While on the other hand, the three-dimensional shaped object can also be used as various kinds of models or replicas in a case where organic powder material (e.g., resin powder material) is used as the powder material.

Taking a case as an example wherein the metal powder is used as the powder material, and the three-dimensional shaped object produced therefrom is used as the metal mold, the selective laser sintering method will now be briefly described. A powder is firstly transferred onto abase plate 21 by a movement of a squeegee blade 23, and thereby a powder layer 22 with its predetermined thickness is formed on the base plate 21 (see FIG. 22A). Then, a predetermined portion of the powder layer is irradiated with a light beam “L” to form a solidified layer 24 (see FIG. 22B). Another powder layer is newly provided on the solidified layer thus formed, and is irradiated again with the light beam to form another solidified layer. In this way, the powder-layer forming and the solidified-layer forming are alternately repeated, and thereby allowing the solidified layers 24 to be stacked with each other (see FIG. 22C). The alternate repetition of the powder-layer forming and the solidified-layer forming leads to a production of a three-dimensional shaped object with a plurality of the solidified layers integrally stacked therein. The lowermost solidified layer 24 can be provided in a state of adhering to the surface of the base plate 21. Therefore, there can be obtained an integration of the three-dimensional shaped object and the base plate. The integrated “three-dimensional shaped object” and “base plate” can be used as the metal mold as they are.

### PATENT DOCUMENTS (RELATED ART PATENT DOCUMENTS)

PATENT DOCUMENT 1: Japanese Unexamined Patent Application Publication No. 2002-115004

PATENT DOCUMENT 2: Japanese Unexamined Patent Application Publication No. 2000-73108

### DISCLOSURE OF THE INVENTION

### Problems to be Solved by the Invention

There is a case when a surface of the three-dimensional shaped object is subjected to a machining process. Specifically, in order to form the three-dimensional shaped object with a better shape accuracy, a surface of the solidified layer of the three-dimensional shaped object may be subjected to the machining process. A rotary machining tool such as a ball end mill is generally used at a point in time when the surface machining process is performed.

For example, when the ball end mill is used to perform the surface machining process, a machining resistance of the ball end mill cannot be ignored, and also the ball end mill may contact a waste caused by the machining, which may make a life time of the ball end mill shoter.

Under these circumstances, the present invention has been created. That is, an object of the present invention is to provide a manufacturing method of the three-dimensional shaped object, the method being capable of making a life time of a machining tool longer when the machining of the surface of the solidified layer is performed by using the machining tool.

### Means for Solving the Problems

In order to achieve the above object, an embodiment of the present invention provides a method for manufacturing a three-dimensional shaped object by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by forming a new powder layer on the formed solidified layer, followed by irradiation of a predetermined portion of the newly formed powder layer with the light beam,

wherein a surface of the solidified layer is subjected to a machining process, the machining process being performed on a basis of a condition of an ultrasonic vibration.

### Effect of the Invention

According to an embodiment of the present invention, it is possible to make the life time of the machining tool longer when the machining of the surface of the solidified layer is performed by using the machining tool.

### BRIEF DESCRIPTION OF THE DRAWINGS

FIG. 1A is a perspective view schematically showing a technical concept of an embodiment of the present invention.

FIG. 1B is a cross-sectional view schematically showing a technical common knowledge of the skilled person.

FIG. 2 is a cross-sectional view schematically showing that a machining process for a surface of a solidified layer is performed by using a machining tool with an ultrasonic vibration.

FIG. 3 is a cross-sectional view schematically showing that the ultrasonic vibration of the machining tool is performed by using a vibration mechanism.

FIGS. 4A-4C are cross-sectional views schematically showing that the surface of the solidified layer is subjected to a rough process followed by a machining-finishing process on a basis of a condition of the ultrasonic vibration.

FIGS. 5A-5C are cross-sectional views schematically showing that the surface of the solidified layer is subjected to the rough process followed by a polishing-finishing process on the basis of the condition of the ultrasonic vibration.

FIGS. 6A-6D are cross-sectional views schematically showing that the surface of the solidified layer is sequentially subjected to the rough process, the machining-finishing process and the polishing-finishing process on the basis of the condition of the ultrasonic vibration.

FIG. 6αA is a cross-sectional view schematically showing that each surface of a plurality of the solidified layers is sequentially subjected to the rough process, the machining-finishing process, and polishing-finishing process on the basis of the condition of the ultrasonic vibration.

FIG. 6αB is a cross-sectional view schematically showing that each surface of a plurality of the solidified layers is subjected to the rough process, and subsequently the surfaces of the plurality of the solidified layers are subjected to the machining-finishing process and the polishing-finishing process as a whole.

FIG. 7 is a cross-sectional view schematically showing that the machining process for the surface of the solidified layer is performed on the basis of the condition of an ultrasonic elliptical vibration.

FIG. 8 is a cross-sectional view schematically showing that the machining process of the surface of the solidified layer is performed on a condition that a forming table is subjected to the ultrasonic vibration.

FIG. 9 is an enlarged photograph of a portion subjected to the machining process with no vibration.

FIG. 10 is an enlarged photograph of a portion subjected to the machining process with the ultrasonic vibration.

FIG. 11 is an enlarged photograph showing an abrasion state of a tip portion of the machining tool upon a completion of the machining process with no vibration.

FIG. 12 is an enlarged photograph showing the abrasion state of the tip portion of the machining tool upon a completion of the machining process with the ultrasonic vibration.

FIG. 13 is a graph showing a technical relationship between a machined distance of the surface of the solidified layer and an abrasion length of the tip portion of the machining tool.

FIG. 14 is an enlarged photograph of a waste caused by the machining process with no vibration.

FIG. 15 is an enlarged photograph of a waste caused by the machining process with the ultrasonic vibration.

FIG. 16 is a graph showing a technical relationship between a machined distance of the surface of the solidified layer and a machining resistance of the machining tool.

FIG. 17 is an enlarged photograph of a state of a burr occurrence upon the performing of the machining process with no vibration.

FIG. 18 is an enlarged photograph of a state of a burr occurrence upon the performing of the machining process with the ultrasonic vibration.

FIG. 19 is an enlarged photograph of a machined portion with no vibration.

FIG. 20 is an enlarged photograph of a machined portion with the ultrasonic vibration.

FIG. 21 is a photograph of the machining tool (e.g., end mill) used upon the machining process.

FIGS. 22A-22C are cross-sectional views schematically illustrating a laser-sintering/machining hybrid process fora selective laser sintering method.

FIG. 23 is a perspective view schematically illustrating a construction of a laser-sintering/machining hybrid machine.

FIG. 24 is a flow chart of general operations of a laser-sintering/machining hybrid machine.

### MODES FOR CARRYING OUT THE INVENTION

The present invention will be described in more detail with reference to the accompanying drawings. It should be noted that configurations/forms and dimensional proportions in the drawings are merely for illustrative purposes, and thus not the same as those of the actual parts or elements.

The term “powder layer” as used in this description means a “metal powder layer made of a metal powder” or “resin powder layer made of a resin powder”, for example. The term “predetermined portion of a powder layer” as used herein substantially means a portion of a three-dimensional shaped object to be manufactured. As such, a powder present in such predetermined portion is irradiated with a light beam, and thereby the powder undergoes a sintering or a melting and subsequent solidification to form a shape of a three-dimensional shaped object. Furthermore, the term “solidified layer” substantially means a “sintered layer” in a case where the powder layer is a metal powder layer, whereas term “solidified layer” substantially means a “cured layer” in a case where the powder layer is a resin powder layer.

The directions of “upper” and “lower”, which are directly or indirectly used herein, are ones based on a positional relationship between a base plate and a three-dimensional shaped object. The side in which the manufactured three-dimensional shaped object is positined with respect to the based plate is “upper”, and the opposite direction thereto is “lower”. The “vertical direction” described herein substantially means a direction in which the solidified layers are stacked, and corresponds to “upper and lower direction” in drawings. The “horizontal direction” described herein substantially means a direction vertical to the direction in which the solidified layers are stacked, and corresponds to “right to left direction” in drawings.

### Selective Laser Sintering Method

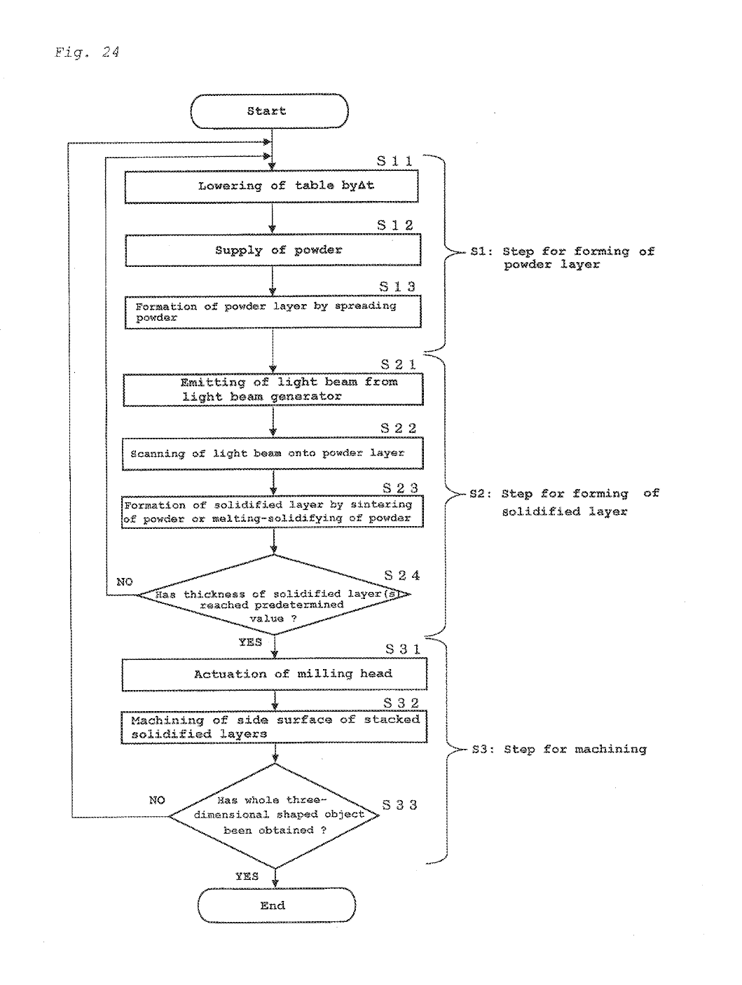

First of all, a selective laser sintering method, on which an embodiment of the manufacturing method of the present invention is based, will be described. By way of example, a laser-sintering/machining hybrid process wherein a machining is additionally carried out in the selective laser sintering method will be especially explained. FIGS. 22A-22C schematically show a process embodiment of the laser-sintering/machining hybrid. FIGS. 23 and 24 respectively show major constructions and operation flow regarding a metal laser sintering hybrid milling machine for enabling an execution of a machining process as well as the selective laser sintering method.

As shown in FIG. 23, the laser-sintering/milling hybrid machine 1 is provided with a powder layer former 2, a light-beam irradiator 3, and a machining means 4.

The powder layer former 2 is a means for forming a powder layer with its predetermined thickness through a supply of powder (e.g., a metal powder or a resin powder). The light-beam irradiator 3 is a means for irradiating a predetermined portion of the powder layer with a light beam “L”. The machining means 4 is a means for milling the side surface of the stacked solidified layers, i.e., the surface of the three-dimensional shaped object.

As shown in FIGS. 22A-22C, the powder layer former 2 is mainly composed of a powder table 25, a squeegee blade 23, a forming table 20 and a base plate 21. The powder table 25 is a table capable of vertically elevating/descending in a “storage tank for powder material” 28 whose outer periphery is surrounded with a wall 26. The squeegee blade 23 is a blade capable of horizontally moving to spread a powder 19 from the powder table 25 onto the forming table 20, and thereby forming a powder layer 22. The forming table 20 is a table capable of vertically elevating/descending in a forming tank 29 whose outer periphery is surrounded with a wall 27. The base plate 21 is a plate for a three-dimensional shaped object. The base plate is disposed on the forming table 20 and serves as a platform of the three-dimensional shaped object.

As shown in FIG. 23, the light-beam irradiator 3 is mainly composed of a light beam generator 30 and a galvanometer mirror 31. The light beam generator 30 is a device for emitting a light beam “L”. The galvanometer mirror 31 is a means for scanning an emitted light beam “L” onto the powder layer, i.e., a scan means of the light beam “L”.

As shown in FIG. 23, the machining means 4 is mainly composed of an end mill 40 and an actuator 41. The end mill 40 is a machining tool for milling the side surface of the stacked solidified layers, i.e., the surface of the three-dimensional shaped object. The actuator 41 is a driving means for allowing the end mill 40 to move toward the position to be machined.

Operations of the laser sintering hybrid milling machine 1 will now be described in detail. As can be seen from the flowchart of FIG. 24, the operations of the laser sintering hybrid milling machine 1 are mainly composed of a powder layer forming step (S1), a solidified layer forming step (S2), and a machining step (S3). The powder layer forming step (S1) is a step for forming the powder layer 22. In the powder layer forming step (S1), first, the forming table 20 is descended by Δt (S11), and thereby creating a level difference Δt between an upper surface of the base plate 21 and an upper-edge plane of the forming tank 29. Subsequently, the powder table 25 is elevated by Δt, and then the squeegee blade 23 is driven to move from the storage tank 28 to the forming tank 29 in the horizontal direction, as shown in FIG. 22A. This enables a powder 19 placed on the powder table 25 to be spread onto the base plate 21 (S12), while forming the powder layer 22 (S13). Examples of the powder for the powder layer include a “metal powder having a mean particle diameter of about 5 μm to 100 μm” and a “resin powder having a mean particle diameter of about 30 μm to 100 μm (e.g., a powder of nylon, polypropylene, ABS or the like”. Following this step, the solidified layer forming step (S2) is performed. The solidified layer forming step (S2) is a step for forming a solidified layer 24 through the light beam irradiation. In the solidified layer forming step (S2), a light beam “L” is emitted from the light beam generator 30 (S21). The emitted light beam “L” is scanned onto a predetermined portion of the powder layer 22 by means of the galvanometer mirror 31 (S22). The scanned light beam can cause the powder in the predetermined portion of the powder layer to be sintered or be melted and subsequently solidified, resulting in a formation of the solidified layer 24 (S23), as shown in FIG. 22B. Examples of the light beam “L” include carbon dioxide gas laser, Nd:YAG laser, fiber laser, ultraviolet light, and the like.

The powder layer forming step (S1) and the solidified layer forming step (S2) are alternately repeated.

This allows a plurality of the solidified layers 24 to be integrally stacked with each other, as shown in FIG. 22C.

When the thickness of the stacked solidified layers 24 reaches a predetermined value (S24), the machining step (S3) is initiated. The machining step (S3) is a step for milling the side surface of the stacked solidified layers 24, i.e., the surface of the three-dimensional shaped object. The end mill 40 is actuated in order to initiate an execution of the machining step (S31). For example, in a case where the end mill 40 has an effective milling length of 3 mm, a machining can be performed with a milling depth of 3 mm. Therefore, supposing that “Δt” is 0.05 mm, the end mill 40 is actuated when the formation of the sixty solidified layers 24 is completed. Specifically, the side face of the stacked solidified layers 24 is subjected to the surface machining (S32) through a movement of the end mill 40 driven by the actuator 41. Subsequent to the surface machining step (S3), it is judged whether or not the whole three-dimensional shaped object has been obtained (S33). When the desired three-dimensional shaped object has not yet been obtained, the step returns to the powder layer forming step (S1). Thereafter, the steps S1 through S3 are repeatedly performed again wherein the further stacking of the solidified layers 24 and the further machining process therefor are similarly performed, which eventually leads to a provision of the desired three-dimensional shaped object.

### Manufacturing Method of the Present Invention

An embodiment of the present invention is characterized by the machining step for the surface of the solidified layer in the selective laser sintering method.

A technical common knowledge of the skilled person (i.e., the skilled person in the technical field of the three-dimensional shaped object) regarding the machining process for the surface of the solidified layer before describing a feature of the present invention.

### Technical Common Knowledge of Skilled Person

Upon the machining process of the surface of the solidified layer, a side surface of the solidified layer is subjected to the machining process by using a rotary machining tool such as the end mill. In this regard, it is a general for the skilled person that the machining process by using the rotary machining tool is performed with no vibration. This is because a provision of the vibration during the machining process for the side surface of the solidified layer is not effective, which is attributed to such a technical common knowledge of the skilled person that a vertical directional vibration of the machining tool is relatively easier than a horizontal directional vibration thereof upon the vibration of the machining tool, since a machining device having the rotary machining tool mainly has a function for rotating the rotary machining tool.

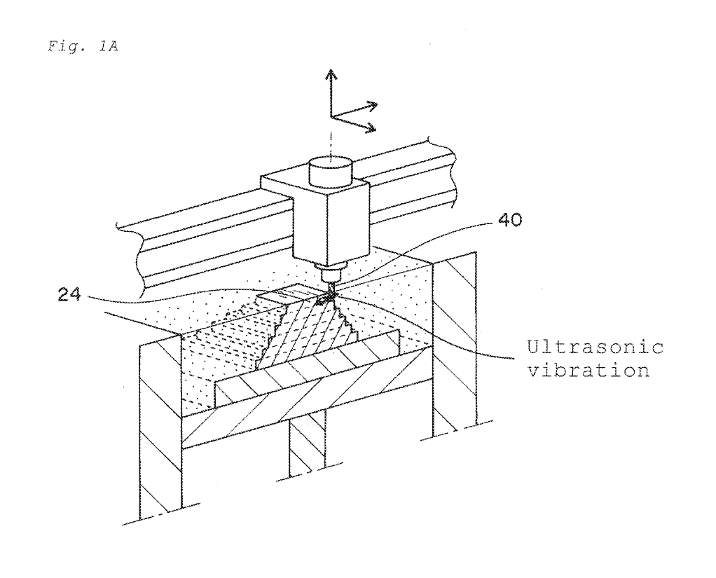

In FIG. 1B, a surface of the three-dimensional shaped object comprised of the stacked solidified layers is subjected to a machining process such that a steped portion 70 is formed at the side surface of the solidified layer 24, the machining process being performed on the basis of the condition that the machining tool is vibrated in the vertical direction. In such a case, the skilled person's technical common knowledge is that the machining tool 47 with the vertical directional vibration does not effectively serve to machine a surface extending in a direction (i.e., horizontal direction) different from the vertical direction which is the vibration direction. Specifically, the skilled person's technical common knowledge is that the machining tool 47 with the vertical directional vibration does not effectively serve to machine a horizontal surface 70a of the steped portion 70. Thus, a mark in a shape of a circle arises in a machined portion of the solidified layer due to an insufficient vertical directional vibration of the rotary machining tool 47 with respect to the horizontal surface 70a, the mark being attributed to the machining. As a result, the machined portion may have a large surface roughness (see a rightmost view and an enlarged view thereof in FIG. 1B). Accordingly, the skilled person's technical common knowledge is that the machining tool with the vibration is not necessary to machine the side surface of the three-dimensional shaped object having a variety of outer configurations to be manufactured by the selective laser sintering method. Especially, in light of the above skilled person's technical common knowledge, it is more obvious that the machining tool is not provided with an “ultrasonic vibration”. Please note that, in the ultrasonic vibration, its degree of the vibration condition is relatively high. Furthermore, PATENT DOCUMENT 2 (i.e., Japanese Unexamined Patent Application Publication No. 2000-73108) discloses that a steped portion formed at a side surface of a solidified layer is subjected to the machining process on the basis of the condition of a normal vibration. Please note that PATENT DOCUMENT 2 does not disclose at all that the machining process of the steped portion is performed on the basis of the condition of the “ultrasonic vibration” which makes the above skilled person's technical knowledge more remarkable.

The present invention is characterized in that the machining process of the surface of the solidified layer is performed on the basis of the condition of the ultrasonic vibration, the machining process on the condition of the ultrasonic vibration being consciously/intentionally contrary to the above skilled person's technical common knowledge.

A manufacturing method according to an embodiment of the present invention will be specifically described hereinafter.

### Technical Concept of Present Invention

A technical concept of the present invention will be described with reference to FIG. 1A before specific embodiments of the present invention are described.

The technical concept of the present invention is that “the machining process of the surface of the solidified layer 24 is performed on the basis of the condition of the ultrasonic vibration”. Briefly, as shown in FIG. 1A, the concept of the present invention is. that “a portion to be machined in the surface of the solidified layer 24 is provided with the ultrasonic vibration”. The “ultrasonic vibration” described herein means a vibration having a frequency of 20-120 kHz, preferably 25-100 kHz, more preferably 30-80 kHz, or even more preferably 35-60 kHz, 35-45 kHz for example, 40 kHz as an example.

In the present invention, the portion to be machined in the surface of the solidified layer 24 is provided with the ultrasonic vibration upon the machining of the surface of the solidified layer, which allows alternate “contact” and “non-contact” between the machining tool 40 and the portion to be machined in the surface of the solidified layer 24. In other words, the ultrasonic vibration contributes to an increase of an “intermittent” contact between the machining tool 40 and the portion to be machined. Thus, the increase of the intermittent contact allows an increase of the number of the contact between the machining tool 4C and the portion to be machined, which can make a size of a waste arising from the portion to be machined smaller, the waste being caused by the machining. The smaller size of the waste allows a prevention of a contact of the machining tool 40 with the waste. Furthermore, the present invention allows the increase of “intermittent” contact between the machining tool 40 and the portion to be machined. In other words, the present invention allows a prevention of a “continuous” or “constant” contact between the machining tool 40 and the portion to be machined in the surface of the solidified layer 24 upon the machining. The prevention of the “continuous” or “constant” allows a reduction of the machining resistance of the machining tool 40 to the portion to be machined in the surface of the solidified layer 24, and allows a prevention of a heat caused by the machining. Accordingly, it is possible to prevent a damage of the machining tool 40 and thereby to make a life time of the machining tool 40 longer.

The mark in the shape of circle arises in the machined portion of the solidified layer upon the machining of the surface of the solidified layer by using the machining tool (e.g. the rotary machining tool), the mark being attributed to the machining. As a result, the machined portion may have the large surface roughness. In this regard, the present invention allows the prevention of the “continuous” or “constant” contact between the machining tool 40 and the portion to be machined in the surface of the solidified layer 24 upon the machining, as described above. Therefore, the arising of the mark attributed to the machining can be prevented, which can make the surface roughness of the machined portion smaller.

The alternate “contact” and “non-contact” between the machining tool and the portion to be machined in the surface of the solidified layer may be performed in a normal vibration-condition (i.e., a non-ultrasonic vibration-condition). In this regard, a frequency of the normal vibration-condition is lower than that of the ultrasonic vibration. Thus, the number of the contact between the machining tool and the portion to be machined in the surface of the solidified layer becomes smaller, and a contact time therebetween becomes longer. As a result, it is difficult to obtain the above technical effects on “the provision of the machining tool having the longer lifetime” and “the provision of the machined portion having the smaller surface roughness”.

Hereinafter, specific embodiments of the present invention will be described.

The specific embodiments of the present invention are composed of two embodiments. A first embodiment of the present invention is based on such a technical idea that the machining tool is subjected to the ultrasonic vibration. second embodiment of the present invention is based on such a technical idea that the base plate is subjected to the ultrasonic vibration.

### First embodiment of Present Invention

### Machining Tool with Ultrasonic Vibration

The first embodiment of the present invention will be described hereinafter, the first embodiment of the present invention having the technical idea that “the machining tool is subjected to the ultrasonic vibration”.

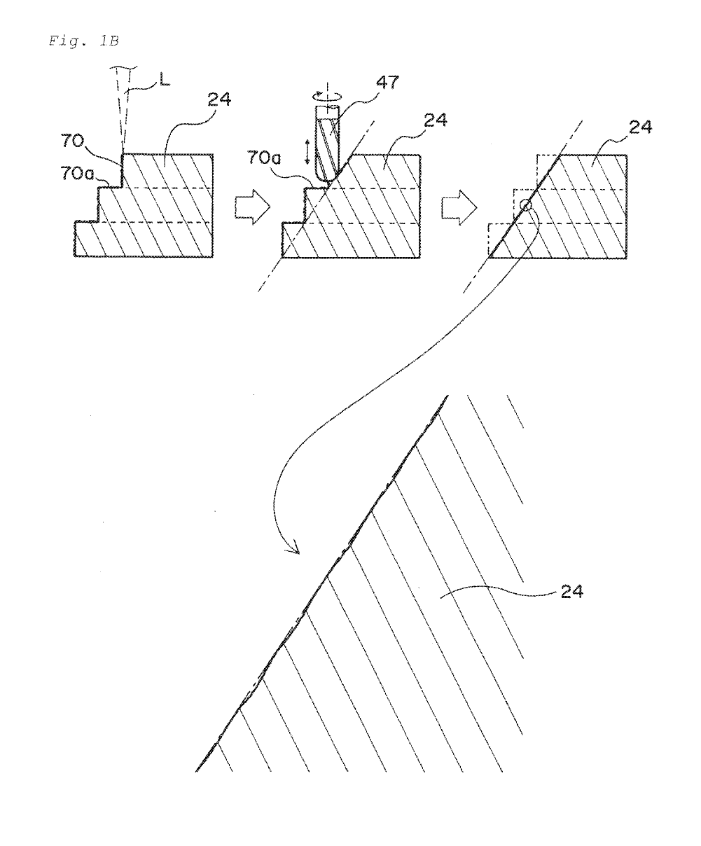

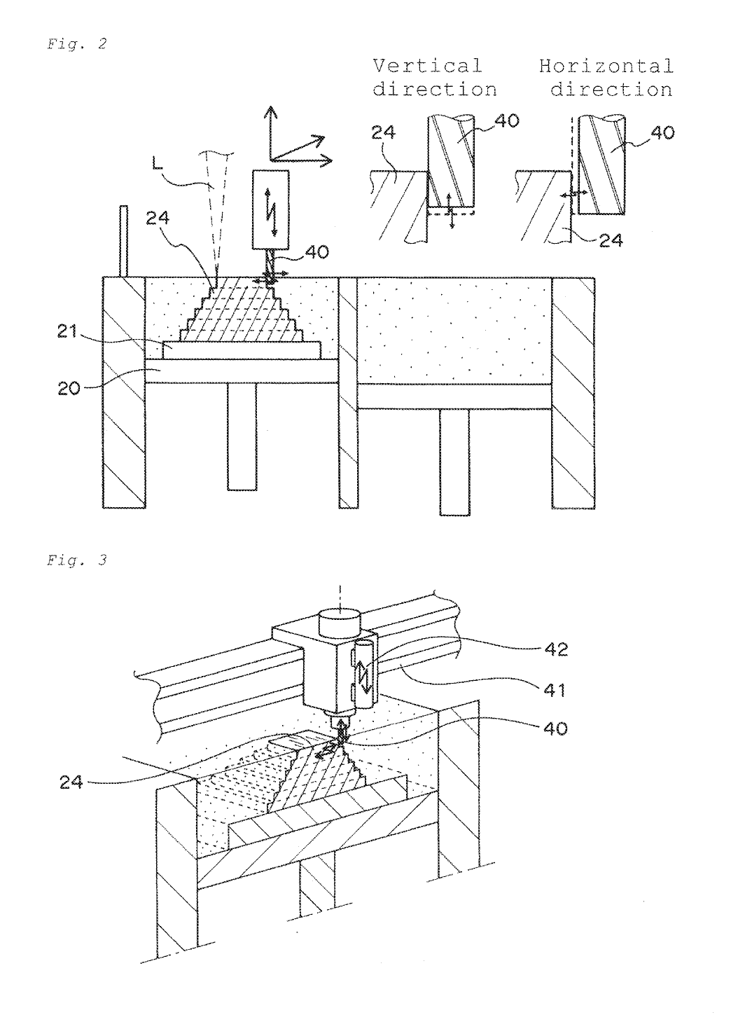

In the first embodiment of the present invention, the machininging for the surface of the solidified layer 24 is performed by using the machining tool 40 with the ultrasonic vibration as shown in FIG. 2, the machining tool being used for the machining process. This means that the first embodiment of the present invention has such a feature that the machining for the surface of the solidified layer 24 is performed in a state that a portion to be machined in the surface of the solidified layer 24 is provided with the ultrasonic vibration by using the machining tool 40. While not being limited to a specific embodiment, a vibration mechanism 42 which can provide the ultrasonic vibration allows the ultrasonic vibration of the machining tool 40 as shown in FIG. 3, the vibration mechanism being disposed on a main shaft of the actuator 41. As the machining tool 40, the “rotary machining tool” or a “non-rotary machining tool” can be used. The “rotary machining tool” described herein means a tool which is capable of a rotary drive upon the machining process. The rotary machining tool has a rotation number/speed of preferably 3000-9000 min⁻¹, more preferably 4000-8000 min⁻¹, even more preferably 5000-7000 min⁻¹. Specific rotary machining tools include a flat end mill and a ball end mill, for example. In a preferable embodiment, the machining process is performed by using the flat end mill as the rotary machining tool. The rotary machining tool may have its surface with an alloy coating (e.g. AlTiN coating) for an improvement of a heat resistance.

Hereinafter, such an embodiment wherein the machining for the surface of the solidified layer is performed by using the “rotary machining tool” with the ultrasonic vibration will be described. The embodiment is composed of three cases. The three cases will be specifically described, respectively.

Firstly, a case 1 will be described.

### Case 1: Rough Process—Machining-Finishing Process

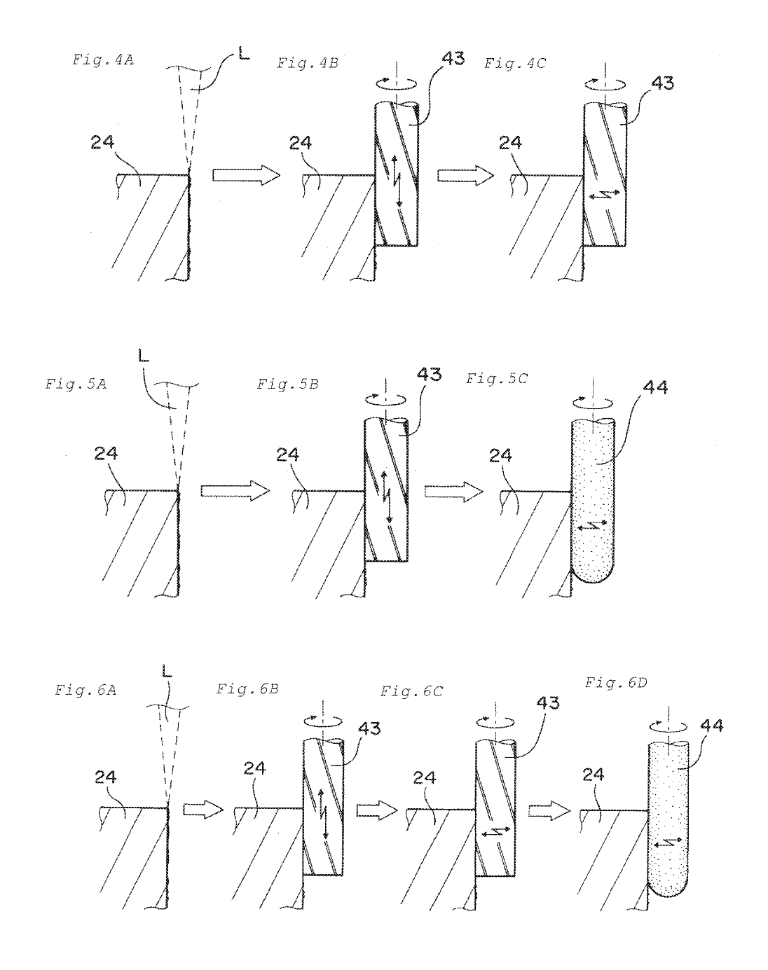

The powder layer is irradiated with the light beam L to form the solidified layer 24 as shown in FIG. 4A, and subsequently the machining of the formed solidified layer 24 is performed based on a rotation movement of the rotary machining tool 43 with the ultrasonic vibration. Specifically, the rotary machining tool 43 with the ultrasonic vibration whose vibration direction is an extension direction of the rotary machining tool 43 is rotated to perform a rough process of the surface of the solidified layer 24 as shown in FIG. 4B, the vibration direction corresponding to a vertical direction. The “rough process” described herein means a machining process of the surface of the solidified layer 24 on a condition of the ultrasonic vibration having a vibration amplitude of 5-50 μm, preferably 10-50 μm, more preferably 20-50 μm, or even more preferably 40-50 μm.

Subsequently, as shown in FIG. 4C, the rotary machining tool 43 is rotated to perform a machining-finishing process of the surface of the solidified layer 24, the rotary machining tool 43 being on a condition of the ultrasonic vibration whose vibration direction is perpendicular to the extension direction of the rotary machining tool 43, the vibration direction corresponding to a horizontal direction. The “machining-finishing process” described herein means a machining process of the surface of the solidified layer 24 on a condition of the ultrasonic vibration having a vibration amplitude of 1-20 μm, preferably 1.5-10 μm, or more preferably 2-5 μm.

As a first technical feature of this embodiment according to the present invention, the vibration direction of the rotary machining tool in the “rough process” is set to the vertical direction (i.e., upper and lower direction). On the other hand, the vibration direction of the rotary machining tool in the “machining-finishing process” is set to the horizontal direction (i.e., right to left direction). This means that the vibration direction of the rotary machining tool 43 is changed from the “vertical direction” to the “horizontal direction” during the machining process. The change of the vibration direction can result from a change of a vibration direction of the vibration mechanism 42 from the “upper and lower direction” to the “right to left direction” as shown in FIG. 3 for example, the vibration mechanism 42 being disposed on the main shaft of the actuator 41 which is movable from right to left or up and down. As a second technical feature of this embodiment according to the present invention, an amplitude of the vertical directional vibration of the rotary machining tool 43 is larger than that of the horizontal directional vibration of the rotary machining tool 43. Specifically, the amplitude of the horizontal directional vibration of the rotary machining tool 43 is preferably set to 2-5 μm for example. On the other hand, the amplitude of the vertical directional vibration of the rotary machining tool 43 is preferably set to 20-50 μm for example.

The rough process allows contact portions between the rotary machining tool 43 and the surface of the solidified layer 24 to become different from each other along the upper and lower direction, the contact portions being formed upon the machining process, which can make the surface roughness of the machined portion in the solidified layer smaller. Specifically, the “rough process” allows a forming of a machined portion having Rz (i.e., an arithmetic mean roughness) of 5 (excluding 5)-10 (excluding 10) μm, preferably 5.5-9.5 μm, more preferably 6.0-9.0 μm, or even more preferably 6.5-8.5 μm, the machined portion corresponding to a portion subjected to the rough process. Subsequently, the machining-finishing process allows a provision of the vibration having the amplitude smaller than that in the rough process, which can provide a more alternate “contact” and “non-contact” between the rotary machining tool 43 and the portion to be machined in the surface of the solidified layer 24. Thus, the more alternate “contact” and “non-contact” can make the surface roughness of the machined portion smaller. Specifically, the “machining-finishing process” allows a forming of the machined portion having Rz of 2.5-8.5 μm, preferably 3.5-7.5 μm, more preferably 4.5-6.5 μm, or even more preferably 5.0-6.0 μm, the machined portion corresponding to a portion subjected to the machining-finishing process. The term “arithmetic mean roughness Rz” is roughness “Rz” defined in JIS B0601. More specifically, the term “arithmetic mean roughness Rz” as used herein means the sum value (μm) of the average of absolute values from the uppermost mountain peak (Yp) to the fifth mountain peak (Yp) and the average of absolute values from the lowermost valley portion (Yv) to the fifth valley portion (Yv), the mountain peak and the valley portion being measured perpendicularly from the average line over the length of an evaluation section that is set in the roughness curve. See JIS B0601:1994.

Secondly, a case 2 will be described.

### Case 2: Rough Process→Polishing-Finishining Process

The powder layer is irradiated with the light beam L to form the solidified layer 24 as shown in FIG. 5A, and subsequently the machining of the formed solidified layer 24 is performed based on the rotation movement of the rotary machining tool 43 with the ultrasonic vibration. Specifically, the rotary machining tool 43 with the ultrasonic vibration whose vibration direction is the extension direction of the rotary machining tool 43 is rotated to perform the rough process of the surface of the solidified layer 24 as shown in FIG. 5B, the vibration direction corresponding to a vertical direction. Subsequently, as shown in FIG. 5C, a grinding tool 44 with a shaft is rotated to perform a polishing-finishing process of the surface of the solidified layer 24, the grinding tool 44 being on a condition of the ultrasonic vibration whose vibration direction is perpendicular to an extension direction of the grinding tool 44, the vibration direction corresponding to a horizontal direction. In the polishing-finishing process, the grinding tool 44 may not be necessary subjected to the ultrasonic vibration in the horizontal direction. The “grinding tool with the shaft” means a tool whose tip portion has a grind stone for polishing the surface of the solidified layer, the grinding stone corresponding to a polishing member.

An embodiment according to the present invention has a first feature that the solidified layer is subjected to the “rough process” by using the rotary machining tool 43 having its vertical vibration direction, followed by the “polishing-finishing process” by using the grinding tool 44 with the shaft. An embodiment according to the present invention has a second feature that an amplitude of the vertical directional vibration of the rotary machining tool 43 is larger than that of the horizontal directional vibration of the grinding tool 44 with the shaft. The rough process allows contact portions between the rotary machining tool 43 and the surface of the solidified layer 24 to become different from each other along the upper and lower direction, the contact portions being formed upon the machining process, which can make the surface roughness of the machined portion in the solidified layer smaller. Specifically, the “rough process” allows a forming of the machined portion having Rz of 5 (excluding 5)-10 (excluding 10) μm, preferably 5.5-9.5 μm, more preferably 6.0-9.0 μm, or even more preferably 6.5-8.5 the machined portion corresponding to a portion subjected to the rough process. In the subsequent “polishing-finishing process”, the rough processed portion in the surface of the solidified layer 24 is subjected to the polishing by using the grinding tool 44 with the shaft, which can make the surface roughness of the machined portion in the solidified layer much smaller. Specifically, the “polishing-finishing process” allows a forming of the portion subjected to the polishing-finishing process having Rz of 1-7 μm, preferably 2-6 μm, more preferably 3-5 μm, or even more preferably 3.5-4.5 μm.

Finally, a case 3 will be described.

### Case 3: Rough Process→Machining-Finishing Process→Polishing-Finishing Process)

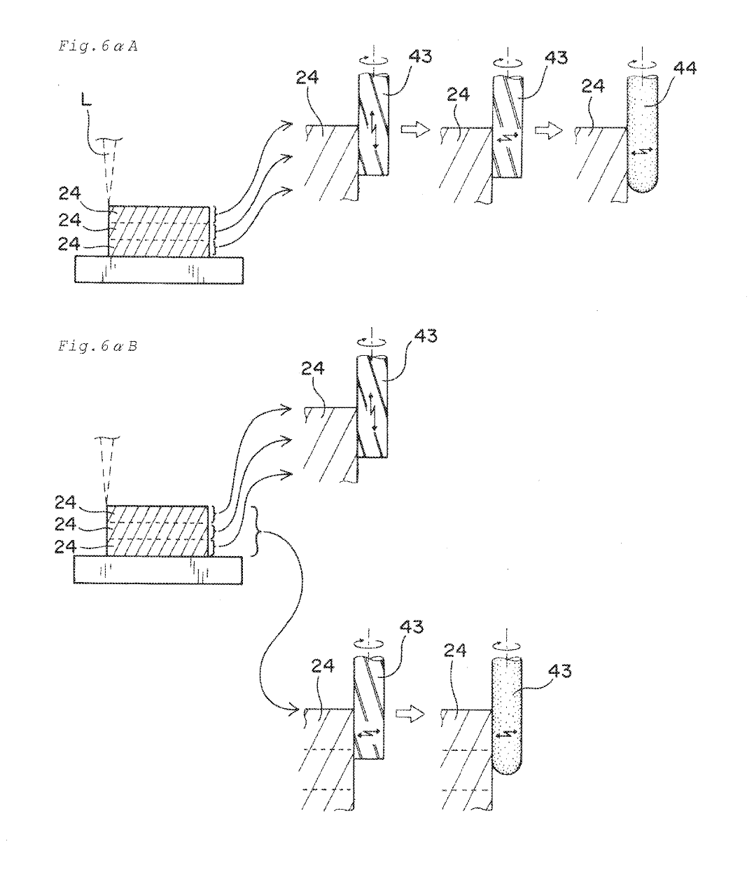

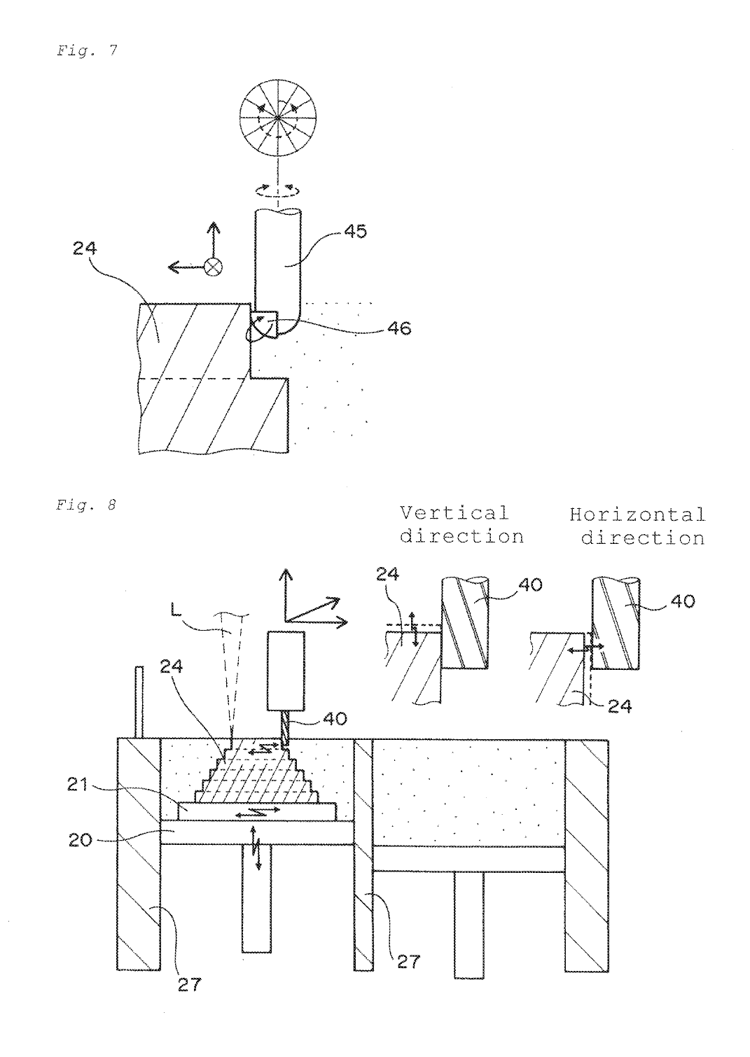

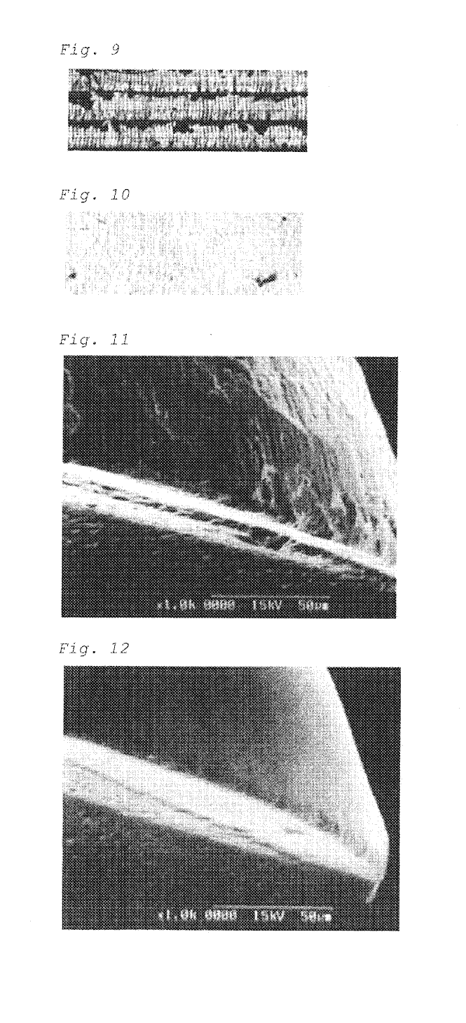

The powder layer is irradiated with the light beam L to form the solidified layer 24 as shown in FIG. 6A, and subsequently the machining of the formed solidified layer 24 is performed based on the rotation movement of the rotary machining tool 43 with the ultrasonic vibration. Specifically, the rotary machining tool 43 with the ultrasonic vibration whose vibration direction is the extension direction of the rotary machining tool 43 is rotated to perform the rough process of the surface of the solidified layer 24 as shown in FIG. 6B, the vibration direction corresponding to a vertical direction. Subsequently, as shown in FIG. 6C, the rotary machining tool 43 is rotated to perform the machining-finishing process of the surface of the solidified layer 24, the rotary machining tool 43 being on a condition of the ultrasonic vibration whose vibration direction is perpendicular to the extension direction of the rotary machining tool 43, the vibration direction corresponding to a horizontal direction. Finally, the grinding tool 44 with the shaft is rotated to perform the polishing-finishing process of the surface of the solidified layer 24 as shown in FIG. 6D, the grinding tool 44 being on the condition of the ultrasonic vibration whose vibration direction is perpendicular to the extension direction of the grinding tool 44, the vibration direction corresponding to the horizontal direction. In the polishing-finishing process, the grinding tool 44 may not be necessary subjected to the ultrasonic vibration in the horizontal direction.

Firstly, the rough process allows contact portions between the rotary machining tool 43 and the surface of the solidified layer 24 to become different from each other along the upper and lower direction, which can make the surface roughness of the machined portion in the solidified layer smaller. Specifically, the “rough process” allows a forming of the machined portion having Rz of 5 (excluding 5)-10 (excluding 10) μm, preferably 5.5-9.5 μm, more preferably 6.0-9.0 μm, or even more preferably 6.5-8.5 μm, the machined portion corresponding to a portion subjected to the rough process. The subsequent machining-finishing process allows a provision of the vibration having the amplitude smaller than that in the rough process, which can provide a more alternate “contact” and “non-contact” between the rotary machining tool 43 and the portion to be machined in the surface of the solidified layer 24. Thus, the more alternate “contact” and “non-contact” can make the surface roughness of the machined portion much smaller. Specifically, the “machining-finishing process” subsequent to the “rough process” allows a forming of a machining-finishing processed portion having Rz of 2.5-8.5 μm, preferably 3.5-7.5 μm, more preferably 4.5-6.5 μm, or even more preferably 5.0-6.0 μm. Furthermore, in subsequent “polishing-finishing process”, the machining-finishing processed portion in the surface of the solidified layer 24 is subjected⁻to the polishing by using the grinding tool 44 with the shaft, which can make a surface roughness of the machining-finishing processed portion even much smaller. Specifically, the “polishing-finishing process” subsequent to the “machining-finishing process” allows a forming of the portion subjected to the polishing-finishing process having Rz of 1-7 μm, preferably 2-6 μm, more preferably 3-5 μm, or even more preferably 3.5-4.5 μm.

In light of the above matters, the case 3 is effective in that it allows a provision of the smaller surface roughness of the machined portion compared to the patterns 1 and 2.

In the case 3, each surface of a plurality of the solidified layers may be sequentially subjected to the rough process, the machining-finishing process by using the rotary machining tool 43 with the ultrasonic vibration, and polishing-finishing process (see FIG. 6αA). Due to the rough process, the machining-finishing process, and polishing-finishing process 43 of each surface, it is possible to more effectively reduce the surface roughness of the machined portion in each of solidified layers 24. Alternatively, each surface of a plurality of the solidified layers may be subjected to the rough process by using the rotary machining tool 43 with the ultrasonic vibration (see FIG. 6αB). Subsequently, the surfaces of the plurality of the solidified layers, each of which was subjected to the rough process, may be subjected to the machining-finishing process and the polishing-finishing process as a whole. When the plurality of the solidified layers 24 have a large surface roughness, each surface of the solidified layers is subjected to the machining process (i.e., rough process) to decrease each surface roughness to a predetermined value. When each surface roughness has the predetermined value, the surfaces of the plurality of the solidified layers are subjected to the machining-finishing process and the polishing-finishing process as a whole to make the surface roughness of each surface much smaller. Accordingly, the surface roughness of the machined portion in each of the solidified layers can be more effectively decreased, which leads to an improvement of the manufacturing efficiency of a desired solidified layer.

Three cases have been described, the cases including an embodiment wherein the machining process for the surface of the solidified layer is performed by using the “rotary machining tool” with the ultrasonic vibration.

An embodiment wherein a “non-rotary machining tool”, not “rotary machining tool” is used as the machining tool for performing the machining process will be described hereinafter.

In an embodiment according to the present invention, a non-rotary machining tool is used as the machining tool for the machining process. In the non-rotary machining tool, a portion for performing the machining process has no function of a rotation motion. The “non-rotary machining tool” means a tool having no function of the rotation motion upon the machining process. The non-rotary machining tool may include a spring necked turning tool which is made of a diamond and/or superhard material for example.

An embodiment according to the present invention has a feature that the non-rotary machining tool having no function of the rotation motion is subjected to the ultrasonic vibration during the machining process. Even when the non-rotary machining tool is used, its ultrasonic vibration is possible and thus it is possible to perform the alternate “contact” and “non-contact” between the machining tool for the machining process (i.e., non-rotary machining tool) and the portion to be machined in the surface of the solidified layer, which can make the lifetime of the non-rotary machining tool longer.

It is preferable that the non-rotary machining tool is subjected to the ultrasonic vibration as described above. Specifically, it is preferable that, by using the non-rotary machining tool with the ultrasonic vibration, a portion to be machined in the surface of the solidified layer is provided with an ultrasonic elliptical vibration.

More specifically, a chip portion 46 disposed on a tip portion of the non-rotary machining tool 45 provides a portion to be machined in the surface of the solidified layer 24 with the ultrasonic elliptical vibration as shown in FIG. 7, the solidified layer being obtained by irradiating the powder layer with the light beam L. The “ultrasonic elliptical vibration” means a vibration whose vibration direction is a combined direction of the “vertical direction” with the “horizontal direction”, each of the “vertical direction” and the “horizontal direction” being a vibration direction upon the use of the rotary machining tool. The ultrasonic elliptical vibration has a vibration amplitude of 1-20 μm, preferably 2-15 μm, or more preferably 3-10 μm. It is preferable that the ultrasonic elliptical vibration has a frequency of 20-40 kHz. In a case where the machining process is performed on a condition of one directional ultrasonic vibration, the waste caused by the machining is generally pushed out in a direction opposite to a direction in which a friction arises, the friction being caused by the machining of the surface of the solidified layer by using the machining tool. This leads to a larger machining resistance and a larger heat occurrence by the machining. In the present invention, the machining process with the ultrasonic elliptical vibration results in a motion of the tip portion of the machining tool along a direction in which the waste caused by the machining is pushed out, which leads to a promotion of a discharge of the waste. Accordingly, the promotion of the discharge allows an improvement for technical effects regarding (i) a decrease of a machining force of the non-rotary machining tool and an abrasion thereof, (ii) an increase of an accuracy of the machining process, and (iii) a prevention of a contact of the non-rotary machining tool with the waste caused by the machining.

The first embodiment of the present invention has been described, the first embodiment being based on such a technical idea that “the machining tool is subjected to the ultrasonic vibration”.

The second embodiment of the present invention will be described hereinafter, the second embodiment being based on such a technical idea that “the base plate is subjected to the ultrasonic vibration”.

### Second Embodiment of Present Invention

### Forming Table with Ultrasonic Vibration

In the second embodiment of the present invention, a forming table 20 with an ultrasonic vibration is used to perform the machining process of the surface of the solidified layer 24, the forming table 20 being provided for forming the powder layer and the solidified layer at an upper region thereof. Specifically, a based plate 21 disposed on the forming table 20 with the ultrasonic vibration is used for the machining process. This means that the second embodiment of the present invention has such a feature that the machining for the surface of the solidified layer 24 is performed in a state that a portion to be machined in the surface of the solidified layer 24 is provided with an ultrasonic vibration which is due to the forming table 20 subjected to the ultrasonic vibration. While not being limited to a specific embodiment, a vibrator which is capable of an ultrasonic vibration in a vertical direction or a horizontal direction may result in the forming table 20 with the ultrasonic vibration in a vertical direction or a horizontal direction, the vibrator being disposed in the base plate 21 or the forming table 20. A use of the forming table 20 on the condition of the ultrasonic vibration in the vertical direction allows contact portions between the machining tool 40 and the surface of the solidified layer 24 to become different from each other along the upper and lower direction, the contact portions being formed upon the machining process, which can make the surface roughness of the machined portion in the solidified layer smaller. A use of the forming table 20 on the condition of the ultrasonic vibration in the horizontal direction allows alternate “contact” and “non-contact” between the machining tool 40 and the portion to be machined in the surface of the solidified layer 24, which can make the surface roughness of the machined portion in the solidified layer smaller. It is preferable that the forming table 20 is provided with the vertical directional ultrasonic vibration in light of a position-relationship between the forming table 20 and the wall 27, the position-relationship being that a side surface of the forming table 20 contacts the wall 27.

Although several embodiments of the present invention (i.e., the method for manufacturing the three-dimensional shaped object) have been hereinbefore described, the present invention is not limited to these embodiments. It will be readily appreciated by the skilled person that various modifications are possible without departing from the scope of the present invention.

### EXAMPLES

Examples related to the present invention will be described hereinafter.

### Example 1

### Comparative Example <Machining Process with No Vibration>

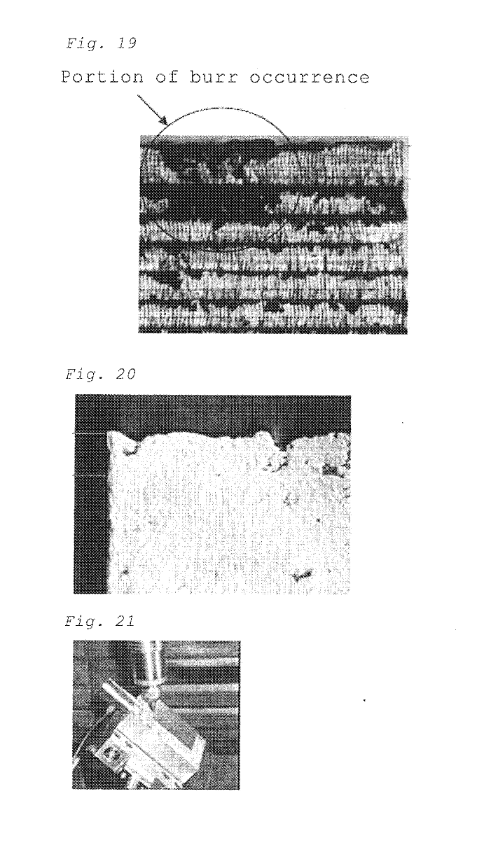

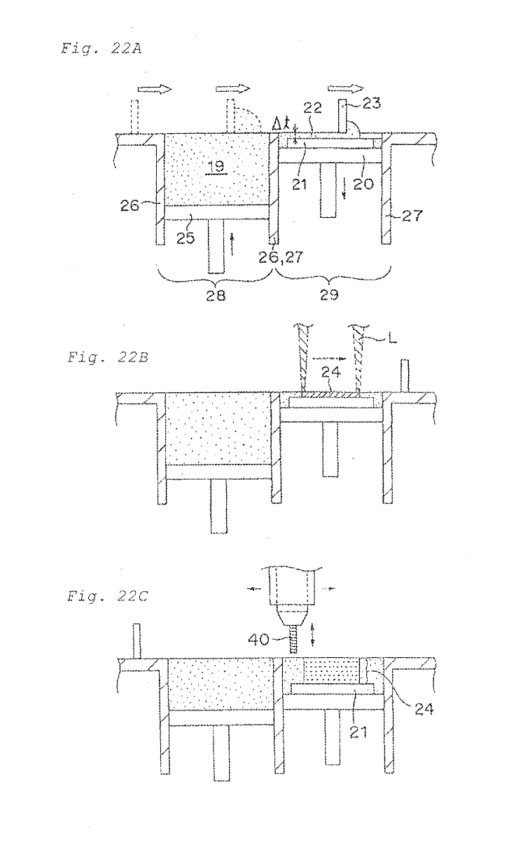

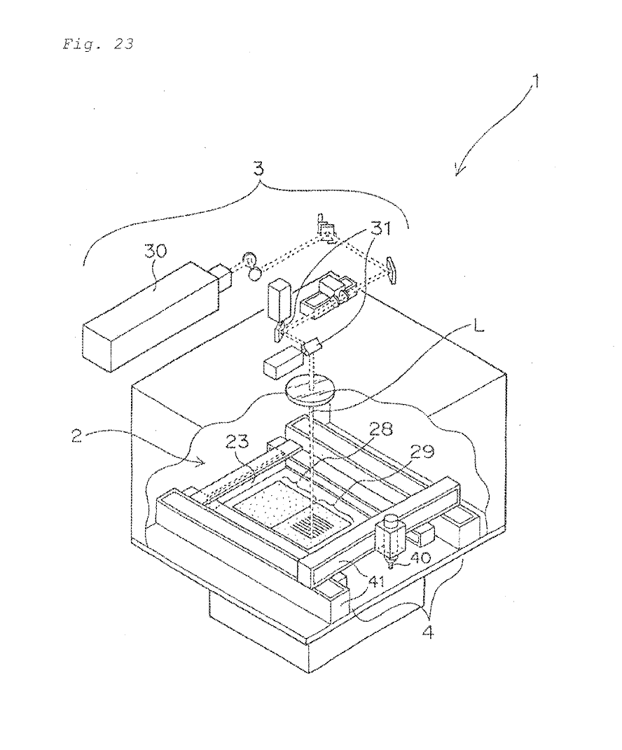

The machining process of the solidified layer having a groove portion a concave portion) was performed by using the machining tool. Specifically, as shown in FIG. 21, the machining process of the surface of the groove portion was performed by using the end mill with AlTiN coating (R: 0.3 mm) on a condition of a non-vibration. An enlarged photograph of the machined portion is shown in FIG. 9.

### Working Example <Machining Process→Polishing Process on Condition of Ultrasonic Vibration>

The machining process of the surface of the solidified layer having the groove portion was performed by using the end mill with the ultrasonic vibration, the end mill having AlTiN coating and R: 0.3 mm. Subsequently, the polishing process for a machined surface was performed by using the grinding tool with the shaft subjected to the ultrasonic vibration. Another enlarged photograph of the machined and subsequent polished portion on the condition of the ultrasonic vibration is shown in FIG. 10. The machining process and the polishing process subjected to the ultrasonic vibration respectively were performed in accordance with the following conditions:

Rotation number: 6000 min⁻¹;

Vibration amplitude: 30-50 μm;

Frequency: 40 kHz; and

Vibration direction: Extension direction of end mill

### Result

The portion subjected to the machining process and subsequent polishing process each of which was on the condition of the ultrasonic vibration had little rough surface. On the other hand, the portion subjected to the machining process with no vibration had a remarkable rough surface.

### Example 2

### Comparative Example <Machining Process with No Vibration>

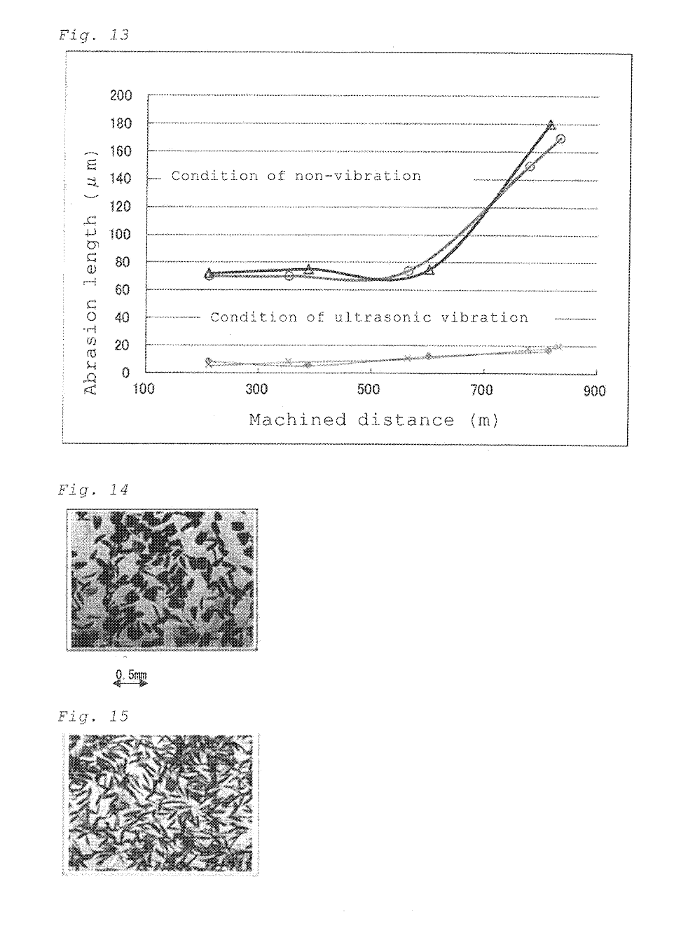

The machining process for the surface of the solidified layer was performed by using the end mill with AlTiN coating (R: 0.3 mm) on a condition of a non-vibration. An abrasion state of a tip portion of the machining tool is shown in FIG. 11, the abration state being a state upon a completion of the machining process with no vibration. The machined distance of the surface of the solidified layer upon the completion of the machining process was 100 m.

### Working Example <Machining Process with Ultrasonic Vibration>

The machining process for the surface of the solidified layer was performed by using the end mill with the ultrasonic vibration, the end mill having AlTiN coating and R: 0.3 mm. Another abrasion state of the tip portion of the machining tool is shown in FIG. 12, the abration state being a state upon a completion of the machining process with the ultrasonic vibration. The machined distance of the surface of the solidified layer upon the completion of the machining process was 100 m. The machining process with the ultrasonic vibration was performed in accordance with the following conditions:

Rotation number: 6000 min⁻¹;

Vibration amplitude: 30-50 μm;

Frequency: 40 kHz; and

Vibration direction: Extension direction of end mill

### Result

The tip portion of the end mill upon the completion of the machining process on the condition of the ultrasonic vibration had little abration surface even though the machined distance of the surface of the solidified layer was 100 m as of the completion of the machining process. On the other hand, the tip portion of the end mill upon the completion of the machining process with no vibration had a remarkable abration surface when the machined distance of the surface of the solidified layer was 100 m as of the completion of the machining process.

### Example 3

### Comparative Example <Machining Process with No Vibration>

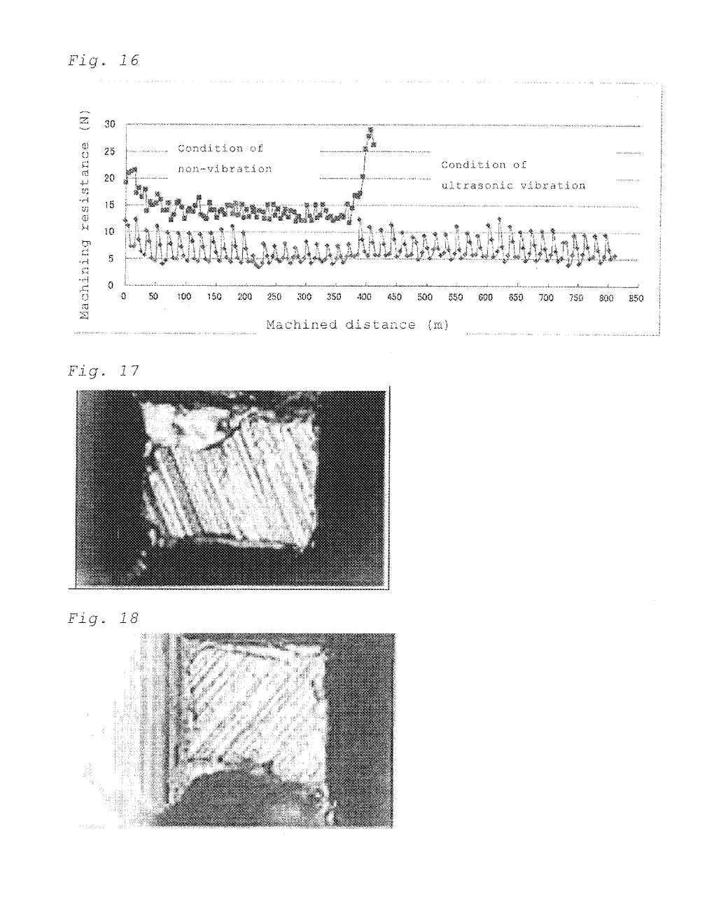

The machining process for the surface of the solidified layer was performed by using the end mill with AlTiN coating (R: 0.3 mm) on a condition of a non-vibration. A technical relationship between a machined distance of the surface of the solidified layer and an abrasion length of the tip portion of the machining tool was studied. A result of the technical relationship is shown in FIG. 13.

### Working Example <Machining Process with Ultrasonic Vibration>

The machining process for the surface of the solidified layer was performed by using the end mill with the ultrasonic vibration, the end mill having AlTiN coating and R: 0.3 mm.

Upon the use of the end mill on the condition of the ultrasonic vibration, another technical relationship between the machined distance of the surface of the solidified layer and the abrasion length of the tip portion of the machining tool is shown in FIG. 13. The machining process with the ultrasonic vibration was performed in accordance with the following conditions:

Rotation number: 6000 min⁻¹;

Vibration amplitude: 30-50 μm;

Frequency: 40 kHz; and

Vibration direction: Extension direction of end mill

### Result

In a case where the machining process of the surface of the solidified layer was performed by using the endmill with the ultrasonic vibration, the abrasion length of the tip portion of the endmill was 20 μm or less even though the machined distance was about 800 m, and thus the tip portion had little abrasion state (see FIG. 13) . On the other hand, in a case where the machining process of the surface of the solidified layer was performed by using the endmill with no vibration, the abrasion length of the tip portion of the endmill was about 70 μm when the machined distance was 600 m or less. The abrasion length of the tip portion was remarkably larger when the machined distance was more than 600 m. The abrasion length of the tip portion was about 180 μm when the machined distance was about 800 m.

### Example 4

### Comparative Example <Machining Process with No Vibration>

The machining process for the surface of the solidified layer was performed by using the end mill with AlTiN coating (R: 0.3 mm) on a condition of a non-vibration. An enlarged photograph of a waste caused by the machining process with no vibration is shown in FIG. 14, the enlarged photograph showing the waste upon a completion of the machining process. The machined distance of the surface of the solidified layer upon the completion of the machining process was 100 m.

### Working Example <Machining Process with Ultrasonic Vibration>

The machining process for the surface of the solidified layer was performed by using the end mill with the ultrasonic vibration, the end mill having AlTiN coating and R: 0.3 mm. Another enlarged photograph of a waste caused by the machining process with the ultrasonic vibration is shown in FIG. 15, the enlarged photograph showing the waste upon a completion of the machining process. The machined distance of the surface of the solidified layer upon the completion of the machining process was 100 m. The machining process with the ultrasonic vibration was performed in accordance with the following conditions:

Rotation number: 6000 min⁻¹;

Vibration amplitude: 30-50 μm;

Frequency: 40 kHz; and

Vibration direction: Extension direction of end mill

### Result

A size of the waste caused by the machining with the ultrasonic vibration was smaller than that of the waste caused by the machining with no vibration (see FIG. 15). With respect to the former, its size was not a size causing a contact of the end mill with the waste.

### Example 5

### Comparative Example <Machining Process with No Vibration>

The machining process for the surface of the solidified layer was performed by using the end mill with AlTiN coating (R: 0.3 mm) on a condition of a non-vibration. A technical relationship between a machined distance of the surface of the solidified layer and a machining resistance of the endmill with no vibration was studied. A result of the technical relationship is shown in FIG. 16.

### Working Example <Machining Process with Ultrasonic Vibration>

The machining process for the surface of the solidified layer was performed by using the end mill with the ultrasonic vibration, the end mill having AlTiN coating and R: 0.3 mm. Another technical relationship between the machined distance of the surface of the solidified layer and the machining resistance of the endmill with the ultrasonic vibration was studied. A result of another technical relationship is shown in FIG. 16. The machining process with the ultrasonic vibration was performed in accordance with the following conditions:

Rotation number: 6000 min⁻¹;

Vibration amplitude: 30-50 μm;

Frequency: 40 kHz; and

Vibration direction: Extension direction of end mill

### Result

In a case where the machining process of the surface of the solidified layer was performed by using the endmill with the ultrasonic vibration, the machining resistance of the endmill with the ultrasonic vibration was about 4 N to about 12 N even though the machined distance was about 800 m (see FIG. 16). On the other hand, in a case where the machining process of the surface of the solidified layer was performed by using the endmill with no vibration, the machining resistance of the endmill with no vibration was about 15 N when the machined distance was about 350 m or less. The machining resistance of the endmill with no vibration was remarkably larger when the machining resistance was more than about 350 m. The machining resistance of the endmill with no vibration was about 30 N when the machining resistance was about 400 m (see FIG. 16).

### Example 6

### Comparative Example <Machining Process with No Vibration>

The machining process for the surface of the solidified layer was performed by using the end mill with AlTiN coating (R: 0.3 mm) on a condition of a non-vibration. A state of a burr occurrence upon the machining process with no vibration was studied. A result of the state of the burr occurrence is shown in FIG. 17.

### Working Example <Machining Process with Ultrasonic Vibration>

The machining process for the surface of the solidified layer was performed by using the end mill with the ultrasonic vibration, the end mill having AlTiN coating and R: 0.3 mm. Another state of a burr occurrence upon the machining process with the ultrasonic vibration was studied. A result of another state of the burr occurrence is shown in FIG. 18. The machining process subjected to the ultrasonic vibration was performed in accordance with the following conditions:

Rotation number: 6000 min⁻¹;

Vibration amplitude: 30-50 μm;

Frequency: 40 kHz; and

Vibration direction: Extension direction of end mill

### Result

In a case where the machining process of the surface of the solidified layer was performed on the condition of the ultrasonic vibration, a prevention of the burr occurrence can be found (see FIG. 18). In a case where the machining process of the surface of the solidified layer was performed with no vibration, the burr occurrence can be found (see FIG. 17).

### Example 7

### Comparative Example <Machining Process with No Vibration>

The machining process for the surface of the solidified layer was performed by using the end mill with AlTiN coating (R: 0.3 mm) on a condition of a non-vibration. An enlarged photograph of a machined portion with no vibration is shown in FIG. 19.

### Working Example <Machining Process with Ultrasonic Vibration>

The machining process for the surface of the solidified layer was performed by using the end mill with the ultrasonic vibration, the end mill having AlTiN coating and R: 0.3 mm. Subsequently, a polishing process for the machined surface was performed by using a grinding tool with a shaft on the condition of the ultrasonic vibration. Another enlarged photograph of a portion subjected to the machining process and the polishing process with the ultrasonic vibration is shown in FIG. 20. The ultrasonic vibration-process was performed in accordance with the following conditions:

Rotation number: 6000 min

Vibration amplitude: 30-50 μm;

Frequency: 40 kHz; and

Vibration direction: Extension direction of end mill

### Result

The portion subjected to the machining process and the polishing process with the ultrasonic vibration had a surface roughness (i.e., Rz) of 3-5 μm. On the other hand, the machined portion with no vibration had a surface roughness (i.e., Rz) of 10-30 μm.

It should be noted that the present invention as described above includes the following aspects:

The first aspect: A method for manufacturing a three-dimensional shaped object by alternate repetition of a powder-layer forming and a solidified-layer forming, the repetition comprising:

(i) forming a solidified layer by irradiating a predetermined portion of a powder layer with a light beam, thereby allowing a sintering of the powder in the predetermined portion or a melting and subsequent solidification of the powder; and

(ii) forming another solidified layer by forming a new powder layer on the formed solidified layer, followed by irradiation of a predetermined portion of the newly formed powder layer with the light beam,

wherein a surface of the solidified layer is subjected to a machining process, the machining process being performed on a basis of a condition of an ultrasonic vibration.

The second aspect: The method according to the first aspect, wherein a machining tool with an ultrasonic vibration is used for the condition of the ultrasonic vibration, the machining tool being used for the machining process.
The third aspect: The method according to the first or second aspect, wherein each of the powder layer and the solidified layer is formed at an upper region of a forming table, and wherein the forming table with an ultrasonic vibration is used for the condition of the ultrasonic vibration.
The fourth aspect: The method according to the second or third aspect, wherein a rotary machining tool is used as the machining tool, and

wherein the rotary machining tool with an ultrasonic vibration is provided while the the rotary machining tool being rotated.

The fifth aspect: The method according to the fourth aspect, wherein a change in a vibration direction of the rotary machining tool is performed between a vertical direction and a horizontal direction during the machining process.
The sixth aspect: The method according to the fifth aspect, wherein an amplitude of the vertical directional vibration of the rotary machining tool is larger than that of the horizontal directional vibration of the rotary machining tool.
The seventh aspect: The method according to any one of the first to sixth aspects, wherein the machining process is performed in at least two steps, the at least two steps comprising a rough process step and a finishing process step.
The eighth aspect: The method according to the seventh aspect, wherein any one of a machining-finishing, a polishing-finishing, and a combination of the machining-finishing and the polishing-finishing is performed as the finishing process, the machining-finishing using the rotary machining tool, the polishing-finishing using a grinding tool with a shaft.
The ninth aspect: The method according to the seventh aspect when appendant to the fifth or sixth aspect, wherein the rough process is performed by the rotary machining tool with the vertical directional vibration, and subsequently the finishing process is performed by the rotary machining tool with the horizontal directional vibration.
The tenth aspect: The method according to any one of the first to third aspects, wherein a non-rotary machining tool is used as the machining tool which is used for the machining process.
The eleventh aspect: The method according to the tenth aspect, wherein the non-rotary machining tool provides an ultrasonic elliptical vibration.

### INDUSTRIAL APPLICABILITY

The manufacturing method according to an embodiment of the present invention can provide various kinds of articles. For example, in a case where the powder layer is a metal powder layer (i.e., inorganic powder layer) and thus the solidified layer corresponds to a sintered layer, the three-dimensional shaped object obtained by an embodiment of the present invention can be used as a metal mold for a plastic injection molding, a press molding, a die casting, a casting or a forging. While on the other hand in a case where the powder layer is a resin powder layer (i.e., organic powder layer) and thus the solidified layer corresponds to a cured layer, the three-dimensional shaped object obtained by an embodiment of the present invention can be used as a resin molded article.

### CROSS REFERENCE TO RELATED PATENT APPLICATION

The present application claims the right of priority of Japanese Patent Application No. 2015-127888 (filed on Jun. 25, 2015, the title of the invention: “METHOD FOR MANUFACTURING THREE-DIMENSIONAL SHAPED OBJECT”), the disclosure of which is incorporated herein by reference.

### EXPLANATION OF REFERENCE NUMERALS

22 Powder layer
L Light beam
24 Solidified layer
40 Machining tool (e.g., Endmill)
20 Forming table
43 Rotary machining tool
44 Grinding tool with shaft
45 Non-rotary machining tool CLAIMS

1. A method for manufacturing a three-dimensional shaped object by alternate repetition of a powder-layer forming and a solidified-layer forming, the repetition comprising:
(i) forming a solidified layer by irradiating a predetermined portion of a powder layer with a light beam, thereby allowing a sintering of the powder in the predetermined portion or a melting and subsequent solidification of the powder; and
(ii) forming another solidified layer by forming a new powder layer on the formed solidified layer, followed by irradiation of a predetermined portion of the newly formed powder layer with the light beam, wherein a surface of the solidified layer is subjected to a machining process, the machining process being performed on a basis of a condition of an ultrasonic vibration.

2. The method according to claim 1, wherein a machining tool with an ultrasonic vibration is used for the condition of the ultrasonic vibration, the machining tool being used for the machining process.

3. The method according to claim 1, wherein each of the powder layer and the solidified layer is formed at an upper region of a forming table, and wherein the forming table with an ultrasonic vibration is used for the condition of the ultrasonic vibration.

4. The method according to claim 2, wherein a rotary machining tool is used as the machining tool, and wherein the rotary machining tool with an ultrasonic vibration is provided while the the rotary machining tool being rotated.

5. The method according to claim 4, wherein a change in a vibration direction of the rotary machining tool is performed between a vertical direction and a horizontal direction during the machining process.

6. The method according to claim 5, wherein an amplitude of the vertical directional vibration of the rotary machining tool is larger than that of the horizontal directional vibration of the rotary machining tool.

7. The method according to claim 1, wherein the machining process is performed in at least two steps, the at least two steps comprising a rough process step and a finishing process step.

8. The method according to claim 7, wherein any one of a machining-finishing, a polishing-finishing, and a combination of the machining-finishing and the polishing-finishing is performed as the finishing process, the machining-finishing using the rotary machining tool, the polishing-finishing using a grinding tool with a shaft.

9. The method according to claim 7 when appendant to claim 5, wherein the rough process is performed by the rotary machining tool with the vertical directional vibration , and subsequently the finishing process is performed by the rotary machining tool with the horizontal directional vibration.

10. The method according to claim 1, wherein a non-rotary machining tool is used as the machining tool which is used for the machining process.

11. The method according to claim 10, wherein the non-rotary machining tool provides an ultrasonic elliptical vibration.
